(19) United States
(12) Patent Application Publication
(10) Pub. No.: US 2010/0040790 A1
(43) Pub. Date: Feb. 18, 2010

(54) AQUEOUS FORMULATIONS AND USE THEREOF

(75) Inventors: Oihana Elizalde, Mannheim (DE); Michael Schmitt, Worms (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/514,321

(22) PCT Filed: Nov. 15, 2007
(86) PCT No.: PCT/EP2007/062363

§ 371 Date: May 11, 2009

(30) Foreign Application Priority Data
Nov. 17, 2006 (EP) 06124353.1

(51) Int. Cl. B05D 3/02; C08K 9/10

(52) U.S. Cl. 427/385.5; 523/205

(57) ABSTRACT

Aqueous formulations comprise
(A) at least one film-forming addition (co)polymer,
(B) particles comprising a core (a) and at least one envelope (b) other than said core (a), and optionally
(C) at least one hydrophobicizing agent.

The present invention concerns aqueous formulations comprising
(A) at least one film-forming addition (co)polymer,
(B) particles comprising a core (a) and at least one envelope (b) other than said core (a), and optionally
(C) at least one hydrophobicizing agent.

The present invention further concerns the use of the present invention's aqueous formulations. The present invention further concerns a process for coating surfaces by using the present invention's aqueous formulations and a process for their production.

For some years there has been appreciable interest in treating surfaces such that they are soil repellent or at least difficult to soil. Various methods involve providing the surfaces with texturing, for example with elevations 5 to 100 μm high and 5 to 200 μm spaced apart. A surface has been endowed with texturing that seeks to emulate the lotus plant, see for example WO 96/04123 and U.S. Pat. No. 3,354,022. However, such an approach is not always advisable and it is unsuitable for treating textile surfaces.

WO 04/74568 discloses a process for finishing textile materials by treatment with at least one aqueous liquor comprising at least one organic polymer and at least one organic or inorganic solid in particulate form, the organic or inorganic solid or solids being present in the liquor in a fraction of at least 5.5 g/l. Silica gel, in particular fumed silica gel, is recommended as solid in particulate form.

EP 1 283 296 discloses coating textile sheetlike constructions with a coating prepared by coating them with 50% to 80% by weight of at least one finely divided material selected from for example potato starch and oxidic materials such as for example silica gel, quartz flour or kaolin, having diameters in the range from 0.5 to 100 μm (at least 80% by weight of the finely divided material), 20% to 50% by weight of a matrix comprising a binder, a fluorinated polymer and if appropriate auxiliaries.

Potato starch, as recommended in EP 1 283 296, however, has a certain solubility in aqueous liquors or floats, so that the diameter of the potato starch particles cannot be optimally controlled during a coating operation. Especially in the case of inorganic solids such as silica gel for example, a certain propensity to agglomerate is observed, which is disadvantageous at application and makes placing of the textural parameters more difficult.

It is further observed that there are many cases where such textiles, coated by the aforementioned methods, possess insufficient washability at times. If, for example, sweaty textiles are washed, it is to be observed that the soil-repellent effect is reduced after the first wash and has virtually disappeared after several wash cycles.

The present invention has for its object to provide formulations with which surfaces, particularly textile surfaces, can be coated such that they subsequently have soil-repellent properties. The present invention further has for its object to provide a process for coating surfaces which avoids the abovementioned disadvantages, particularly in relation to the coating of textile surfaces. The present invention further has for its object to provide coated surfaces which avoid the abovementioned disadvantages and exhibit good soil repellency.

We have found that this object is achieved by the aqueous formulations defined at the beginning.

The aqueous formulations defined at the beginning comprise

(A) at least one film-forming addition (co)polymer,

(B) particles comprising a core (a) and at least one envelope (b) other than said core (a), and optionally

(C) at least one hydrophobicizing agent.

Aqueous formulations according to the present invention comprise one or more film-forming addition (co)polymers (A). By film-forming addition (co)polymers (A) are meant not only dispersed or emulsified but also organisoled (co)polymers such as for example polyacrylates, polyurethanes, polybutadiene, polyolefins such as polyethylene or polypropylene and copolymers thereof, the film-forming addition (co)polymers in question being capable, as a result of a thermal aftertreatment or as a result of treatment with radiation, particularly with IR radiation, of forming a film on a substrate to be coated, without significant damage to the substrate. Preference is given to dispersions or emulsions of polyacrylate or polyurethanes.

Suitable polyacrylates, preferred for use as film-forming addition (co)polymer (A) for the purposes of the present invention, are such addition copolymers, particularly emulsion addition copolymers of at least one monoethylenically unsaturated carboxylic acid or dicarboxylic acid such as for example maleic acid, fumaric acid, crotonic acid, itaconic acid, or preferably (meth)acrylic acid with at least one comonomer such as for example at least one C₁-C₁₀-alkyl ester of at least one monoethylenically unsaturated carboxylic acid or dicarboxylic acid, particularly methyl (meth)acrylate, ethyl acrylate, n-butyl acrylate and 2-ethylhexyl acrylate, and/or at least one further comonomer selected from for example vinylaromatics, for example para-methylstyrene, α-methylstyrene and particularly styrene, and nitrogenous comonomers such as (meth)acrylamide, (meth)acrylonitrile.

In one embodiment of the present invention, polyacrylates useful as binders comprise, in interpolymerized form, at least one reactive comonomer selected from glycidyl (meth)acrylate, acetoacetyl (meth)acrylate and N-methylol (meth)acrylamide.

Suitable polyurethanes, preferred as binders for the purposes of the present invention, are hydroxyl-terminated polyurethanes obtainable by reaction of at least one polyesterol, for example a condensation product of an aliphatic dicarboxylic acid such as succinic acid, glutaric acid and particularly adipic acid with at least one aliphatic diol, for example 1,6-hexandiol, 1,4-butanediol, neopentylglycol, ethylene glycol or diethylene glycol, and a diisocyanate or polyisocyanate and if appropriate further reaction partners. Suitable diisocyanates are aliphatic, cycloaliphatic and aromatic diisocyanates, particularly hexamethylene diisocyanate (HDI), dodecamethylene diisocyanate, 4,4′-diisocyanatocyclohexylmethane (MDI), cyclohexane 1,4-diisocyanate, isophorone diisocyanate (IPDI) and aromatic diisocyanates such as for example tolylene diisocyanate (TDI).

As further reaction partners there may be mentioned for example diols, particularly 1,4-butanediol, and acid-functional molecules, particularly acid-functional diols and acid-functional diamines, examples being 3,3-dihydroxymethylolpropionic acid and

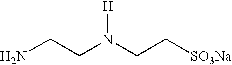

The aqueous formulations according to the present invention further comprise particles (B) comprising a core (a) and at least one envelope (b) other than core (a), and thereafter thermally treated.

In one embodiment of the present invention, particles (B) have a number average diameter in the range from 20 to 1000 nm, preferably in the range from 25 to 475 nm and more preferably in the range from 50 to 300 nm. Particle diameter may be measured using commonly deployed methods such as transmission electron microscopy for example.

In one embodiment of the present invention, the core (a) of particles (B) has an average diameter in the range from 10 to 950 nm, preferably up to 450 nm and more preferably in the range from 15 to 250 nm.

The number average diameter of core (a) and the thickness of shell (b) can advantageously be determined arithmetically by determining the average diameter of core (a) and of shell (b) on the assumption of an appropriate, particularly a complete, conversion in the course of the preparation of particles (B) and using as density in each case the density of core (a) and envelope (b) which were produced in the absence of whichever is the other component, envelope (b) or core (a).

In one embodiment of the present invention, particles (B) have a monomodal distribution of diameter. In another embodiment of the present invention, particles (B) can have a bimodal distribution of diameter.

One embodiment of the present invention comprises particles (B) being present neither in the form of aggregates nor in the form of agglomerates.

One embodiment of the present invention comprises particles (B) having an irregular shape. Preferably, particles (B) have a regular shape, for example ellipsoidal or, in particular, spherical.

Core (a) and envelope (b) each preferably comprise an organic copolymer.

Core (a) and envelope (b) are mutually different. In one embodiment of the present invention, core (a) and envelope (b) comprise different organic copolymers, i.e., copolymers that differ in number or chemical structure, for example. In another embodiment of the present invention, core (a) and envelope (b) comprise different organic copolymers which are prepared from the same comonomers, but in different comonomer ratios.

In one embodiment of the present invention, core (a) and envelope (b) are covalently linked to each other.

In one specific embodiment of the present invention, particles (B) comprise a core-shell polymer, the shell corresponding to the envelope (b).

In one embodiment of the present invention, core (a) comprises a crosslinked copolymer of at least one ethylenically unsaturated compound, for example a copolymer of a vinylaromatic compound or of a C₁-C₁₀-alkyl ester of (meth)acrylic acid. One or more crosslinkers can be used as comonomer for example. Further comonomers useful, if appropriate, for preparing core (a) include one or more compounds free radically copolymerizable with ethylenically unsaturated compounds, examples being C₁-C₁₀-alkyl (meth)acrylates, ω-hydroxy-C₂-C₄-alkylene (meth)acrylates, singly ethylenically unsaturated carboxylic acids, (meth)acrylamide, unsubstituted or singly or doubly substituted with C₁-C₁₀-alkyl or di-C₁-C₁₀-n-alkyl-C₂-C₄-alkylene, especially N,N-dimethylaminopropylmethacrylamide (DMAPMAM).

Examples of suitable vinylaromatic compounds are for example α-methylstyrene, para-methylstyrene, 2,4-dimethylstyrene and especially styrene.

Examples of particularly suitable C₁-C₂₀-alkyl esters of (meth)acrylic acid are n-butyl (meth)acrylate and methyl methacrylate.

Useful crosslinkers include for example di- and trivinylaromatics, for example ortho-divinylbenzene, meta-divinylbenzene and para-divinylbenzene, (meth)acrylates of di- or trihydric alcohols, examples being ethylene glycol di(meth)acrylate, 1,3-propanediol di(meth)acrylate, 1,4-butanediol di(meth)acrylate, 1,6-hexanediol di(meth)acrylate, 1,1,1-trimethylolpropane di(meth)acrylate, 1,1,1-trimethylolpropane tri(meth)acrylate, and also allyl (meth)acrylate and glycidyl (meth)acrylate.

Examples of suitable C₁-C₁₀-alkyl (meth)acrylates are methyl (meth)acrylate, ethyl (meth)acrylate, n-propyl (meth)acrylate, isopropyl (meth)acrylate, n-butyl (meth)acrylate, n-hexyl (meth)acrylate, 2-ethylhexyl (meth)acrylate, n-decyl (meth)acrylate.

Examples of suitable ω-hydroxy-C₂-C₄-alkylene (meth)acrylates are 4-hydroxybutyl (meth)acrylate, 3-hydroxypropyl (meth)acrylate and especially 2-hydroxyethyl (meth)acrylate.

Particularly suitable singly ethylenically unsaturated carboxylic acids are for example maleic acid, fumaric acid, E- and Z-crotonic acids, itaconic acid and especially acrylic acid and methacrylic acid.

Examples of C₁-C₁₀-alkyl- or di-C₁-C₁₀-amino-n-alkyl-C₂-C₄-alkylene-mono- or -disubstituted (meth)acrylamide are N-methyl(meth)acrylamide, N,N-dimethyl-(meth)acrylamide, N-ethyl(meth)acrylamide, N,N-dimethylaminoethyl(meth)acrylamide and N,N-dimethylaminopropyl(meth)acrylamide.

Organic crosslinked copolymers for core (a) may be prepared using for example up to 25 mol %, preferably up to 20 mol % and at least 1 mol % of crosslinker with at least 75 mol %, preferably at least 80 mol % and more preferably up to 99 mol % of one or more aforementioned singly ethylenically unsaturated comonomers.

In one embodiment of the present invention, particles (B) also comprise an envelope (b) comprising a crosslinked or crosslinking-capable copolymer of for example at least one ethylenically unsaturated carboxylic acid or at least one ester or amide of an ethylenically unsaturated carboxylic acid.

In one embodiment of the present invention, particles (B) comprise an envelope (b) comprising a crosslinked or further crosslinking-capable copolymer of for example at least one ethylenically unsaturated carboxylic acid or at least one ester or amide of an ethylenically unsaturated carboxylic acid, i.e., the envelope comprises a so-called incipiently crosslinked copolymer.

To accomplish crosslinking of envelope (b), one or more of the above-described crosslinkers may be interpolymerized into the copolymer in question, for example at up to 7% by weight, based on the total weight of particles (B), preferably 0.1% to 5% by weight.

Crosslinking-capable copolymers is to be understood as meaning for example such copolymers as, under the conditions of the thermal treatment in a further step of the process of the present invention, undergo a reaction and crosslink as a result. For example, such copolymers as comprise one or more comonomers having epoxy groups, NH—CH₂OH groups or acetoacetyl groups in interpolymerized form are suitable.

Particularly suitable comonomers having epoxy groups are for example mono- or diglycidyl esters of itaconic acid, maleic acid, fumaric acid, and glycidyl esters of E- and Z-crotonic acids and especially of acrylic acid and of methacrylic acid.

Particularly suitable comonomers having NH—CH₂OH groups are for example reaction products of formaldehyde with singly ethylenically unsaturated carboxamides, especially N-methylolacrylamide and N-methylolmethacrylamide.

Particularly suitable comonomers having acetoacetyl groups are for example (meth)acrylates of alcohols of the general formula I

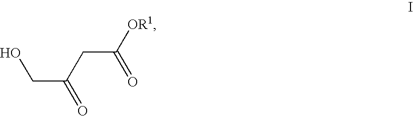

where
R¹ is selected from branched or unbranched C₁-C₁₀-alkyl, such as methyl, ethyl, n-propyl, iso-propyl, n-butyl, iso-butyl, sec-butyl, tert-butyl, n-pentyl, iso-pentyl, sec-pentyl, neopentyl, 1,2-dimethylpropyl, iso-amyl, n-hexyl, iso-hexyl, sec-hexyl, n-heptyl, n-octyl, 2-ethylhexyl, n-nonyl, n-decyl, more preferably unbranched C₁-C₄-alkyl such as methyl, ethyl, n-propyl and n-butyl.

Further suitable comonomers for preparing envelope (b) are for example vinylaromatic compounds, C₁-C₁₀-alkyl (meth)acrylates, ω-hydroxy-C₂-C₄-alkylene (meth)acrylates and (meth)acrylic acid.

In one embodiment of the present invention, core (a) or envelope (b) or core (a) and envelope (b) comprise an anionic copolymer or different anionic copolymers. By anionic copolymers are meant in the context of the present invention such copolymers as are prepared from ethylenically unsaturated compounds which are free radically polymerizable and of which one (a so-called anionic comonomer) carries per molecule at least one group deprotonatable in aqueous formulation, an example being methacrylic acid or vinylphosphonic acid.

In another embodiment of the present invention, core (a) or envelope (b) or core (a) and envelope (b) comprise a cationic copolymer or different cationic copolymers. By cationic copolymers are meant in the context of the present invention such copolymers as are prepared from ethylenically unsaturated compounds which are free radically polymerizable and of which one (a so-called cationic comonomer) carries per molecule at least one group protonatable in aqueous formulation, for example one or more nitrogen atoms having a free electron pair, or cationic groups such as for example quaternary nitrogen atoms built into the polymer chain.

Cationic copolymers may be taken to refer for example to such copolymers as bear free amino groups, for example NH₂ groups, NH(C₁-C₄-alkyl) groups, N(C₁-C₄-alkyl)₂ groups or (C₁-C₄-alkyl)₂N—C₂-C₁₀-alkylene groups, especially (CH₃)₂N—C₂-C₄-alkylene groups.

In one embodiment of the present invention, cationic copolymers under acidic conditions, for example at pH 6 or less, are present in at least partially protonated form.

In one embodiment of the present invention, cationic copolymers may be taken to be such copolymers as comprise in interpolymerized form one or more amides of at least one ethylenically unsaturated carboxylic acid, for example (meth)acrylamide as one of the comonomers.

In one embodiment of the present invention, cationic copolymers are copolymers constructed of at least one nonionic comonomer, for example a vinylaromatic compound such as for example styrene or at least one C₁-C₂₀-alkyl ester of at least one ethylenically unsaturated carboxylic acid, and at least one comonomer having at least one protonatable or quaternized nitrogen atom per molecule.

Cationic copolymers within the meaning of the present invention may also comprise one or more anionic comonomers such as for example (meth)acrylic acid or crotonic acid in interpolymerized form. When cationic copolymers comprise also at least one anionic monomer in interpolymerized form, the molar fraction of cationic comonomers is always higher than the molar fraction of anionic comonomers, for example by 0.5 mol %, based on total cationic copolymer, preferably at least 1 mol % and more preferably 1.5 to 20 mol %.

In one embodiment of the present invention, envelope (b), or crosslinked or crosslinking-capable copolymer present in envelope (b), has a glass transition temperature T_{g} in the range from −50 to +30° C. and preferably in the range from −20 to +30° C.

Particles (B) comprising a core (a) and at least one envelope (b) other than core (a) may be prepared in various ways, for example by multistaged emulsion polymerization with one or more free radical initiators in the presence of one or more emulsifiers or by an emulsion polymerization in the gradient mode. Core (a) is synthesized before envelope (b) is synthesized using a changed composition of comonomer. Preferably, core (a) is prepared by an emulsion polymerization in the seed mode; that is, initially one or more water-insoluble polymers such as for example polystyrene are added in very small particles, for example having a number average diameter in the range from 10 to 30 nm, which then foster droplet formation during the copolymerization.

Aqueous formulations according to the present invention may further comprise at least one hydrophobicizing agent (C).

In one embodiment of the present invention, hydrophobicizing agents (C) are selected from
(C1) halous organic (co)polymers,
(C2) paraffins,
(C3) compounds having at least one C₁₀-C₆₀-alkyl group per molecule, and
(C4) silicones.

Useful halous (co)polymers (C1) include for example chlorinated and especially fluorinated (co)polymers preparable by preferably free radical (co)polymerization of one or more singly or multiply halogenated, preferably chlorinated and more preferably fluorinated, (co)monomers.

Very particularly preferred halous (co)monomers are fluorous olefins such as for example vinylidene fluoride, trifluorochloroethylene, tetrafluoroethylene, hexafluoropropylene, vinyl esters of fluorinated or perfluorinated C₃-C₁₁-carboxylic acids as described for example in U.S. Pat. No. 2,592,069 and U.S. Pat. No. 2,732,370, (meth)acrylic esters of fluorinated or perfluorinated alcohols such as for example fluorinated or perfluorinated C₃-C₁₄-alkyl alcohols, for example (meth)acrylic esters of HO—CH₂—CH₂—CF₃, HO—CH₂—CH₂—C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₆F₁₃, HO—CH₂—CH₂-n-C₈Fl₁₇, HO—CH₂—CH₂—O-n-C₆F₁₃, HO—CH₂—CH₂—O-n-C₈F₁₇, HO—CH₂—CH₂-n-C₁₀F₂₁, HO—CH₂—CH₂-n-C₁₂F₂₅, described for example in U.S. Pat. No. 2,642,416, U.S. Pat. No. 3,239,557 and U.S. Pat. No. 3,462,296.

Useful copolymers further include copolymers of for example (meth)acrylic acid and/or C₁-C₂₀-alkyl esters of (meth)acrylic acid or glycidyl (meth)acrylate with esters of the formula II

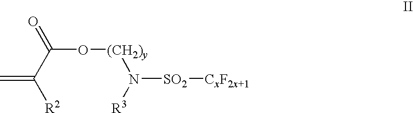

where

R² is CH₃, C₂H₅,

R³ is hydrogen, CH₃, C₂H₅,

x is an integer in the range from 4 to 12, preferably 6 to 8,

y is an integer in the range from 1 to 11, preferably 1 to 6,

or glycidyl (meth)acrylate with vinyl esters of fluorinated carboxylic acids are useful as halous polymers (C).

Useful hydrophobicizing agents (C) further include copolymers of (meth)acrylic esters of fluorinated, especially perfluorinated, C₃-C₁₂-alkyl alcohols such as for example HO—CH₂—CH₂—CF₃, HO—CH₂—CH₂—C₂F₅, HO—CH₂—CH₂-n-C₃F₇, HO—CH₂—CH₂-iso-C₃F₇, HO—CH₂—CH₂-n-C₄F₉, HO—CH₂—CH₂-n-C₆F₁₃, HO—CH₂—CH₂-n-C₈F₁₇, HO—CH₂—CH₂—O-n-C₆F₁₃, HO—CH₂—CH₂—O-n-C₈F₁₇, HO—CH₂—CH₂-n-C₁₀F₂₁, HO—CH₂—CH₂-n-C₁₂F₂₅,

with (meth)acrylic esters of nonhalogenated C₁-C₂₀-alcohols, for example methyl (meth)acrylate, ethyl (meth)acrylate, n-butyl (meth)acrylate, n-propyl (meth)acrylate, 2-ethylhexyl (meth)acrylate, n-octyl (meth)acrylate, n-decyl (meth)acrylate, n-dodecyl (meth)acrylate, n-eicosyl (meth)acrylate.

An overview of further fluorinated polymers or copolymers useful as halous organic (co)polymers (C1) is to be found for example in M. Lewin et al., Chemical Processing of Fibers and Fabrics, Part B, volume 2, Marcel Dekker, New York (1984), pages 172 ff. and pages 178-182.

Further fluorinated (co)polymers useful as halous organic (co)polymers (C1) are described for example in DE 199 120 810.

The process of the present invention may be carried out using one halous (co)polymer (C1) or a plurality of different halous (co)polymers (C1).

Halous (co)polymer (C1) is preferably used in uncrosslinked form to carry out the process of the present invention, but it may crosslink during drying.

Other suitable hydrophobicizing agents (C) are paraffins (C2). Paraffins (C2) may be for example liquid or solid at room temperature and of natural or preferably synthetic origin. Preferred paraffins (C2) are synthetic paraffins such as for example Fischer-Tropsch waxes, high density polyethylene waxes, prepared using Ziegler-Natta catalysts or metallocene catalysts for example, also partially oxidized high density polyethylene waxes having an acid number in the range from 1 to 150 mg KOH/g of paraffin, determined according to DIN 53402, with high density polyethylene waxes comprising not just homopolymer waxes of ethylene, but also copolymers of polyethylene with in total up to 20% by weight of comonomer such as propylene, 1-butene, 1-pentene, 1-hexene, 1-octene, 1-decene or 1-dodecene, especially so-called paraffin waxes and isoparaffin waxes, for example crude paraffins (crude paraffin waxes), slack wax raffinates, deoiled crude paraffins (deoiled crude paraffin waxes), semi- or fully refined paraffins (semi- or fully refined paraffin waxes) and bleached paraffins (bleached paraffin waxes). By paraffin waxes are herein meant in particular room temperature solid paraffins melting in the range from 40 to 80° C., and preferably in the range from 50 to 75° C., i.e. saturated hydrocarbons, branched or unbranched, cyclic or preferably acyclic, individually or preferably as a mixture of a plurality of saturated hydrocarbons. Paraffin waxes in the context of the present invention are preferably composed of saturated hydrocarbons having 18 to 45 carbon atoms. Isoparaffins in the context of the present invention are preferably composed of saturated hydrocarbons having 20 to 60 carbon atoms per molecule.

Useful hydrophobicizing agents (C) further include linear or heterocyclic, preferably heteroaromatic compounds having at least one C₁₀-C₆₀-alkyl group, preferably having a C₁₂-C₄₀-alkyl group per molecule (C3), hereinafter also abbreviated to compound (B3), the C10-C60-alkyl groups being different or preferably the same and branched or preferably unbranched. Preference is given to such compounds (C3) as are able to detach at least one fatty amine or at least one fatty alcohol on heating to temperatures in the range from 120 to 200° C., i.e., an amine or an alcohol having a C₁₀-C60-alkyl group.

Very particular preference is given to compounds of the general formula III

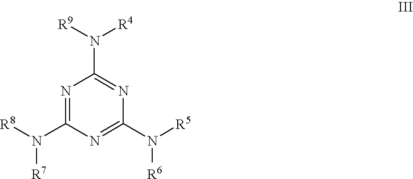

where
R⁴ is selected from C₁₀-C₆₀-alkyl, branched or preferably unbranched, for example n-C₁₀H₂₁, n-C₁₂H₂₅, n-C₁₄H₂₉, n-C₁₆H₃₃, n-C₁₈H₃₇, n-C₂₀H₄₁, n-C₃₀H₆₁, n-C₄₀H₈₁, n-C₅₀H₁₀₁, n-C₆₀H₁₂₁, and CH₂OR¹⁰, where R¹⁰ is selected, C₁₀-C60-alkyl, branched or preferably unbranched, for example n-C₁₀H₂₁, n-C₁₂H₂₅, n-C₁₄H₂₉, n-C₁₆H₃₃, n-C₁₈H₃₇, n-C₂₀H₄₁, n-C₃₀H₆₁, n-C₄₀H₈₁, n-C₅₀H₁₀₁, n-C₆₀H₁₂₁. Carbon numbers and corresponding hydrogen numbers are to be considered averages.
R⁵ to R⁹ are different or preferably the same and are selected from hydrogen, R⁴, CH₂—OH, CH₂—O—C₁-C₁₀-alkyl, especially CH₂—OCH₃, CH₂—OC₂H₅, CH₂—O-n-C₄H₉, CH₂—OCH₂CH₂OH, CH₂—OCH₂CH₂O—C₁-C₁₀-alkyl, especially CH₂—OCH₂CH₂OCH₃, CH₂—OCH₂CH₂OC₂H₅, CH₂—OCH₂CH₂O-n-C₄H₉, CH₂—(OCH₂CH₂)₂O—H, CH₂—(OCH₂CH₂)₂O—C₁-C₁₀-alkyl, especially CH₂—(OCH₂CH₂)₂OCH₃, CH₂—(OCH₂CH₂)₂OC₂H₅, and CH₂—(OCH₂CH₂)₂O-n-C₄H₉.

Further particularly preferred examples of compounds (C3) are compounds of the general formula IV

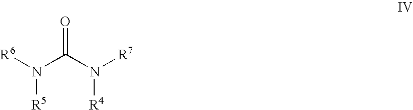

where the variables are each as defined above.

Examples of silicones (C4) are compounds of the general formula V

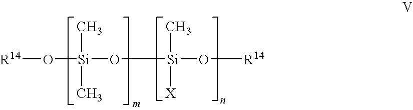

where

R¹⁴ is selected from Si(CH₃)₃ and hydrogen,

X is selected from C₁-C₄-alkyl, particularly methyl, and hydrogen,

epoxy groups, particularly

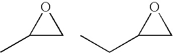

NH₂, aminoalkylene, preferably ω-aminoalkylene, particularly (CH₂)_{w}—NH₂, where w is from 1 to 20 and preferably from 2 to 10 and one or more preferably nonadjacent CH₂ groups may be replaced by oxygen or NH. Examples of X are CH₂—NH₂, CH₂CH₂—NH₂, (CH₂)₃—NH₂, (CH₂)₄—NH₂, (CH₂)₆—NH₂, (CH₂)₃—NH—(CH₂)₂—NH₂, (CH₂)₂—NH—(CH₂)₃—NH₂.

The [Si(CH₃)₂—O] and [SiX(CH₃)—O] units may be disposed for example blockwise or randomly.

m and n are each integers. The sum of n and m can be from 30 to 2000 and preferably from 50 to 1500.

Preferably, m is greater than n. More preferably, n is from 1 to 10, particularly when X is not CH₃, and m is chosen accordingly.

In one embodiment of the present invention, the dynamic viscosity of silicones (C4) is in the range from 100 mPa·s to 50 000 mPa·s measured at 23° C., particularly when X═CH₃ and R¹⁴═Si(CH₃)₃.

One embodiment of the present invention utilizes a hydrophobicizing agent (C) comprising a combination of at least one paraffin (C2) and at least one compound (C3).

Aqueous formulations according to the present invention may be present in the form of aqueous suspensions or emulsions or dispersions, preference being given to aqueous liquors.

Present aqueous formulations and particularly aqueous liquors may have a solids content in the range from 10% to 70% by weight and preferably in the range from 30% to 50% by weight.

In one embodiment of the present invention, aqueous formulations and preferably aqueous liquors have a pH in the range from 2 to 9 and preferably in the range from 3.5 to 7.5.

The present invention further provides for the use of present invention aqueous formulations for coating surfaces. The present invention further provides a process for coating surfaces by using present invention aqueous formulations, hereinafter also referred to as inventive coating process.

The inventive coating process may be carried out by a surface being contacted with inventive aqueous formulation, subjected to the action thereof and thereafter dried.

Surfaces for the purposes of the present invention may consist of any desired material and belong to any desired article. Preference is given to surfaces of flexible substrate. Particular preference is given to surfaces composed of fibrous materials such as for example paper, board, leather, artificial leather, Alcantara, and more particularly surfaces are surfaces of textiles, i.e., they are textile surfaces.

Textiles for the purposes of the present invention are textile fibers, textile intermediate and end products and finished articles manufactured therefrom which, as well as textiles for the apparel industry, also comprise for example carpets and other home textiles and also textile constructions for industrial purposes. These include unshaped constructions such as for example staples, linear constructions such as twine, filaments, yarns, lines, strings, laces, braids, cordage and also three-dimensional constructions such as for example felts, wovens, nonwovens and waddings. Textiles for the purposes of the present invention can be of natural origin, examples being cotton, wool or flax, or synthetic, examples being polyamide, polyester, modified polyester, polyester blend fabrics, polyamide blend fabrics, polyacrylonitrile, triacetate, acetate, polycarbonate, polypropylene, polyvinyl chloride, polyester microfibers and glass fiber fabrics. Textiles composed of cotton are particularly preferred.

The inventive coating process makes it possible to coat one surface (side, face) according to the present invention and the other not, or both surfaces (sides, faces) may be coated by the process of the present invention. For example, there are some garments such as workwear, for example, where it may be sensible to coat the outer surface by the process of the present invention and the inside (body-facing) surface not; and it may be sensible on the other hand for both sides (front and back) of some industrial textiles such as awnings for example to be coated by the process of the present invention.

The temperature for practicing the coating is in itself not critical. The temperature may be in the range from 10 to 60° C. and preferably in the range from 15 to 30° C.

In one embodiment of the present invention, the inventive coating process may be carried out for example by single or multiple spraying, drizzling, overpouring, printing, plasma deposition or pad-mangling.

To practice the coating process of the present invention by using an aqueous liquor or float to contact the surface, the wet pickup may be chosen such that the process of the present invention results in a wet pickup in the range from 25% by weight to 95% by weight and preferably in the range from 60% by weight to 90% by weight.

The coating process of the present invention is in one preferred embodiment of the present invention carried out in commonly deployed machines used for the finishing of textiles, pad-mangles being an example. Preference is given to vertical feed pad-mangles, where the essential element is two rollers in pressed contact with each other, through which the textile is led. The preferably aqueous formulation is filled in above the rollers and wets the textile. The pressure causes the textile to be squeezed off and ensures a constant add-on. In other preferred pad-mangles, textile is first led through a dip bath and then upwardly through two rolls in pressed contact with each other. In the latter case, the pad-mangles are also said to have a vertically upward textile feed. Pad-mangles are described for example in Hans-Karl Rouette, “Handbuch der Textilveredlung”, Deutscher Fachverlag 2003, pages 618 to 620.

In one embodiment of the present invention, the inventive coating process may be practiced by a surface being contacted with at least one inventive aqueous formulation and thereafter thermally treated.

Coating is followed by a thermal treatment of the surface. The thermal treatment may effect drying. The thermal treatment may further effect crosslinking reactions. Preferably, the thermal treatment is carried out at a temperature below the melting point of core (a).

In one embodiment of the present invention, the thermal treatment may be carried out for example at temperatures in the range from 20 to 200° C.

The thermal treatment may be carried out at atmospheric pressure for example. It may also be carried out at reduced pressure, for example at a pressure in the range from 1 to 850 mbar.

The thermal treatment may utilize a heated or unheated stream of gas, in particular a heated or unheated stream of an inert gas such as nitrogen for example. To utilize a heated stream of gas, suitable temperatures range for example from 30 to 200° C., preferably from 120 to 180° C. and more preferably from 150 to 170° C.

The thermal treatment may be carried out continuously or batchwise. The duration of the thermal treatment can be chosen within wide limits. The thermal treatment can typically be carried out for a duration in the range from about 1 second to about 30 minutes and especially in the range from 10 seconds to 3 minutes.

In one embodiment of the present invention, thermal treatment can be carried out in two or more steps, in which case a lower treating temperature is chosen for the first step than for the second and if appropriate subsequent steps.

Hot air drying is an example of a specific suitable method of thermal treatment.

One embodiment of the present invention comprises practicing the process of the present invention by utilizing an aqueous formulation comprising one or more auxiliaries (D), for example up to 10% by weight, based on the entire preferably aqueous formulation. Especially when one or more textile surfaces are to be treated, it may be preferable to include one or more auxiliaries (D) in preferably aqueous formulation utilized for the purposes of the present invention, in which case auxiliaries (D) are selected from biocides, thickeners, foam inhibitors, wetting agents, plasticizers, hand modifiers (hand-modifying agents), fillers, crosslinkers (hardeners) and filmers.

An example of a biocide useful as an auxiliary (D) is 1,2-benzisothiazolin-3-one (BIT) (commercially available as Proxel® brands from Avecia Lim.) and its alkali metal salts; other suitable biocides are 2-methyl-2H-isothiazol-3-one (MIT) and 5-chloro-2-methyl-2H-isothiazol-3-one (CIT). In general, from 10 to 150 ppm of biocide will be sufficient, based on preferably aqueous formulation.

Useful auxiliaries (D) further include one or more thickeners, which may be of natural or synthetic origin. Suitable synthetic thickeners are poly(meth)acrylic compounds, polycarboxylic acids, polyethers, polyimines, polyamides and polyurethanes, especially copolymers comprising 85% to 95% by weight of acrylic acid, 4% to 15% by weight of acrylamide and about 0.01% to 1% by weight of the (meth)acrylamide derivative of the formula VI

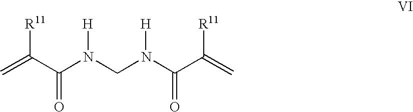

having molecular weights M_{w} in the range from 100 000 to 200 000 g/mol, in each of which R¹¹ is methyl or preferably hydrogen. Examples of thickeners of natural origin are agar, carrageenan, modified starch and modified cellulose.

The amount of thickener included may be for example in the range from 0% to 10% by weight, preferably in the range from 0.05% to 5% by weight and more preferably in the range from 0.1% to 3% by weight, based on aqueous formulation used in the process of the present invention.

Examples of foam inhibitors useful as auxiliaries (D) are room temperature liquid silicones, nonethoxylated or singly or multiply ethoxylated.

Examples of wetting agents useful as auxiliaries (D) are alkylpolyglycosides, alkyl phosphonates, alkylphenyl phosphonates, alkyl phosphates and alkylphenyl phosphates.

Examples of plasticizers useful as auxiliaries (D) are ester compounds selected from the groups of the aliphatic or aromatic di- or polycarboxylic acids fully esterified with alkanols and of the at least singly alkanol-esterified phosphoric acid.

Alkanols are C₁-C₁₀-alkanols in one embodiment of the present invention.

Preferred examples of aromatic di- or polycarboxylic acids fully esterified with alkanol are fully alkanol-esterified phthalic acid, isophthalic acid and mellitic acid; specific examples are di-n-octyl phthalate, di-n-nonyl phthalate, di-n-decyl phthalate, di-n-octyl isophthalate, di-n-nonyl isophthalate, di-n-decyl isophthalate.

Preferred examples of aliphatic di- or polycarboxylic acids fully esterified with alkanol are for example dimethyl adipate, diethyl adipate, di-n-butyl adipate, diisobutyl adipate, dimethyl glutarate, diethyl glutarate, di-n-butyl glutarate, diisobutyl glutarate, dimethyl succinate, diethyl succinate, di-n-butyl succinate, diisobutyl succinate and also mixtures thereof.

Preferred examples of at least singly alkanol-esterified phosphoric acids are C₁-C₁₀-alkyl di-C₆-C₁₄-aryl phosphates such as isodecyl diphenyl phosphate.

Further suitable examples of plasticizers are aliphatic or aromatic di- or polyols at least singly esterified with C₁-C₁₀-alkylcarboxylic acid at least singly.

Preferred examples of aliphatic or aromatic di- or polyols at least singly esterified with C₁-C₁₀-alkylcarboxylic acid is 2,2,4-trimethylpentane-1,3-diol monoisobutyrate.

Further suitable plasticizers are polyesters obtainable by polycondensation of aliphatic dicarboxylic acid and aliphatic diol, for example adipic acid or succinic acid and 1,2-propanediol, preferably having an M_{w} of 200 g/mol, and polypropylene glycol alkylphenyl ether, preferably having an M_{w} of 450 g/mol.

Further suitable plasticizers are polypropylene glycols etherified with two different alcohols and having a molecular weight M_{w} in the range from 400 to 800 g/mol, wherein preferably one of the alcohols may be an alkanol, especially a C₁-C₁₀-alkanol, and the other alcohol may preferably be an aromatic alcohol, for example o-cresol, m-cresol, p-cresol and especially phenol.

Examples of fillers useful as an auxiliary (D) are melamine and pigments in particulate form.

Examples of hand improvers useful as an auxiliary (D) are silicone emulsions, i.e., aqueous emulsions of silicones which may preferably bear hydrophilic groups such as for example OH groups or alkoxylate groups.

Examples of crosslinkers (hardeners) useful as an auxiliary (D) are condensation products of urea, glyoxal and formaldehyde, if appropriate etherified with preferably linear C₁-C₄-alkanol, especially doubly, triply or quadruply methanol- or ethanol-etherified

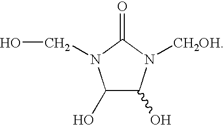

Crosslinkers (hardeners) useful as an auxiliary (D) further include isocyanurates and especially hydrophilicized isocyanurates and also mixed hydrophilicized diisocyanates/isocyanurates, for example the reaction product of C₁-C₄-alkyl polyethylene glycol with the isocyanurate of hexamethylene diisocyanate (HDI). Examples of suitable crosslinkers of this type are known from EP-A 0 486 881 for example.

Diethylene glycol is an example of a film-former (film-forming assistant) useful as an auxiliary (D).

In a further embodiment of the present invention, surface to be coated is provided with a primer (E) prior to the actual coating, then with at least one aqueous formulation according to the present invention. Primer (E) preferably endows the surface to be coated in accordance with the present invention with a charge which is opposite to the charge of particles (B) (see hereinbelow) and in particular their envelope (b). When, for example, such particles (B) as have a cationic envelope (b) are to be used, it is advantageous to employ an anionic primer (E). When, however, such particles (B) as have an anionic envelope (b) are to be used, it is advantageous to employ a cationic primer (E).

Suitable primers (E) may be for example polymeric or nonpolymeric in nature. Suitable polymeric primers may for example have a number average molecular weight in the range from 5000 to 500 000 g/mol.

Useful cationic primers (E) include for example polyethyleneimine and especially aminosiloxanes such as for example siloxanes at least one (CH₂)_{w}NH—R¹² group in each of which w is an integer in the range from 1 to 10 and especially from 2 to 7 and R¹² is selected from hydrogen, preferably linear C₁-C₄-alkyl and (CH₂)_{w}NH—R¹³, where R¹³ is selected from hydrogen and preferably linear C₁-C₄-alkyl, also polyvinyl-imidazole. Further suitable cationic primers (E) are polymers of diallyl di-C₁-C₄-alkyl-ammonium halide, in each of which C₁-C₄-alkyl is preferably linear.

Further suitable cationic primers (E) are reaction products of equimolar amounts of preferably cyclic diamines with epichlorohydrin and an alkylating agent such as for example dimethyl sulfate, C₁-C₁₀-alkyl halide, especially methyl iodide, or benzyl halide, especially benzyl chloride. Such reaction products may have molecular weights M_{w} in the range from 1000 to 1 000 000 g/mol and are constructed as follows, illustrated with reference to the example of the reaction products of equimolar amounts of piperazine with epichlorohydrin and benzyl chloride:

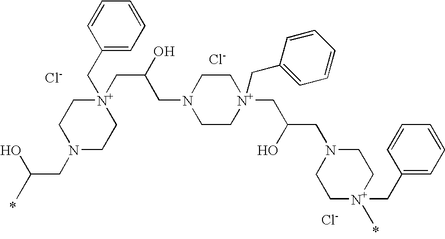

Suitable anionic primers (E) are for example homo- or copolymers of anionic monomers, especially of ethylenically unsaturated sulfonic acids, ethylenically unsaturated amine oxides or (meth)acrylic acid, if appropriate with one or more C₁-C₁₀-alkyl esters of (meth)acrylic acid. Further suitable anionic primers are for example anionic polyurethanes, i.e., herein such polyurethanes as comprise at least one sulfonic acid group or carboxylic acid group per molecule, preparable using 1,1-dimethylolpropionic acid for example.

To use one or more primers (E), it is preferable for it to be used in an aqueous formulation and to be applied prior to the coating with particles (B). Suitable operating techniques include for example spraying, bedrizzling and especially pad-mangling.

The application of primer (E) and the coating with film-forming addition (co)polymer (A) and particles (B) can be respectively followed and preceded by thermal treatment, in which case the conditions of the thermal treatment correspond to the conditions described above.

One embodiment of the present invention comprises applying a cationic primer (E) to cotton surface, treating thermally if appropriate and subsequently coating with inventive aqueous formulation. Another embodiment of the present invention comprises applying no primer (E) to cotton surface and immediately coating with inventive aqueous formulation. This is followed by thermal treatment in each case.

Another embodiment of the present invention comprises applying an anionic primer (E) to polyester surface, treating thermally if appropriate and subsequently coating with inventive aqueous formulation. This is followed by thermal treatment.

The present invention further provides coated surfaces produced by the process of the present invention.

The present invention further provides surfaces coated with filmed (co)polymer (A), particles (B) comprising a core (a) and at least one envelope (b) other than said core (a), and optionally at least one hydrophobicizing agent (C).

Surfaces in accordance with the present invention can advantageously be produced by the above-described process of the present invention. Surfaces in accordance with the present invention are textured and repel water and have little tendency to soil.

One embodiment of the present invention comprises any auxiliary (D) or auxiliaries (D) used being applied only in traces, if at all, to surfaces of the present invention, and thus being essentially absent from the coated surfaces of the present invention.

In one embodiment of the present invention, surfaces of the present invention are characterized in that the treatment results in a coating which may be nonuniform or preferably uniform. Uniform is to be understood as meaning that the texturing is regular, while nonuniform means that the texturing is irregular, i.e., there are textured areas and nontextured areas on the surface.

In one embodiment of the present invention, surfaces in accordance with the present invention comprise a coating having an average thickness in the range from 50 nm to 5 μm, preferably in the range from 100 nm to 1 μm and more preferably up to 500 nm.

In one embodiment of the present invention, the coating applied in accordance with the present invention has an add-on in the range from 0.2 to 10 g/m² and preferably in the range from 1 to 2 g/m².

In one embodiment of the present invention, surfaces in accordance with the present invention are surfaces of textiles. Textile surfaces in accordance with the present invention do not just possess good hydrophobicity and are soil repellent, but also have good durabilities, especially durability to washing or laundering.

The present invention further provides a process for producing inventive aqueous formulations, hereinafter also known as inventive production process. The inventive production process can be carried out by mixing
(A) at least one film-forming addition (co)polymer,
(B) particles comprising a core (a) and at least one envelope (b) other than said core (a),
(C) optionally at least one hydrophobicizing agent, and
(D) optionally at least one auxiliary
   and water together in any order.

The production of film-forming addition (co)polymers is known per se. Hydrophobicizing agents (C) and auxiliaries (D) are recited above.

Particles (B) can be prepared for example by emulsion polymerization, for example by stagewise emulsion polymerization or by emulsion polymerization in the gradient mode.

Suitable comonomers for producing core (a) and envelope (b) of particles (B) are described above.

An emulsion polymerization to produce particles (B) is preferably carried out using at least one initiator. At least one initiator may be a peroxide. Examples of suitable peroxides are alkali metal peroxodisulfates such as for example sodium peroxodisulfate, ammonium peroxodisulfate, hydrogen peroxide, organic peroxides such as diacetyl peroxide, di-tert-butyl peroxide, diamyl peroxide, dioctanoyl peroxide, didecanoyl peroxide, dilauroyl peroxide, dibenzoyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, di-tert-butyl peroxide, tert-butyl hydroperoxide, cumene hydroperoxide, tert-butyl peroxi-2-ethyl-hexanoate and diisopropyl peroxidicarbamate. Also suitable are azo compounds such as for example azobisisobutyronitrile, azobis(2-amidopropane) dihydrochloride and 2,2′-azobis(2-methylbutyronitrile).

Redox initiators are likewise suitable for carrying out the inventive manufacturing process, consisting of peroxides and oxidizable sulfur compounds for example. Very particular preference is given to systems consisting of acetone bisulfite and organic peroxide such as tert-C₄H₉—OOH, Na₂S₂O₅ (sodium disulfite) and organic peroxide such as tert-C₄H₉—OOH or NaO—CH₂SO₂H and organic peroxide such as tert-C₄H₉—OOH. Similarly, systems such as for example ascorbic acid/H₂O₂ are particularly preferred. The temperature chosen for conducting the inventive manufacturing process may be in the range from 20 to 105° C., preferably in the range from 50 to 85° C. The advantageously chosen temperature is dependent on the disintegration characteristics of the initiator or initiators used.

The pressure conditions for conducting the inventive preparation process are generally not critical in that for example pressures in the range from atmospheric pressure to 10 bar are suitable.

The inventive production process may be carried out using at least one emulsifier, which can be anionic, cationic or nonionic and selected from those enumerated as emulsifiers (C).

The duration chosen for conducting the inventive production process can be in the range from 30 minutes to 12 hours, and the range from 2 to 6 hours is preferred.

Various procedures can be chosen for carrying out the inventive preparation process, for example a batch (discontinuous) operation or semi- or fully continuous processes such as feed stream addition processes, which can also be operated in staged mode.

Seed procedures as described in EP 0 810 831 for example are contemplated as well. Seed procedure is particularly effective at producing particles (B) having a particle size distribution of particularly good reproducibility.

It is very particularly preferred to prepare a core (a) first, by emulsion polymerization. Core (a) is generated in particulate form in the reaction mixture. However, core (a) is left unpurified and the reaction mixture is mixed with comonomers, if appropriate further initiator or initiators and if appropriate emulsifier to produce in this way envelope (b) which is directly polymerized onto core (a).

Without preferring any one particular theory, it appears to be plausible that envelope (b) and core (a) are in many cases not just physically attached to each other but covalently linked to each other.

In one embodiment of the present invention, a deodorization is carried out after the preparation of particles (B), for example a chemical deodorization through addition of further initiator on completion of the addition of comonomer.

The invention is illustrated by working examples.

The glass transition temperature T_{g} was determined using a Mettler-Toledo TA8200 series DSC822 differential scanning calorimeter with a TSO 801RO sample robot. The differential scanning calorimeter was equipped with an FSR5 temperature sensor. The method of DIN 53765 was followed.

Evaluation was based on the second heating curve in each case. Cool in each case down to −110° C., heating rate: 20° C./min, heat up to 150° C., maintain at 150° C. for 5 minutes, then cool down to −110° C., heating rate: 20° C./min, heat up to 150° C.

The particle diameter distribution of particles (B) was in each case determined in accordance with ISO 13321 using a Malvern Coulter Counter.

### I. Preparation of Film-Forming Addition (Co)Polymers (A), Particles (B) And Inventive Formulations

### I.1. Preparation of Film-Forming Addition (Co)Polymer (A.1)

The following mixtures were prepared:

### Mixture I.1.1

20 g of compound of formula VII as 40% by weight solution in water

R¹⁵—[N(CH₂CH₂O)₆H]₂ VII

where R¹⁵ is cis-(CH₂)₈—CH═CH—(CH₂)₇CH₃.

2.8 g of acrylic acid, 128 g of styrene, 245.2 g of n-butyl acrylate,

12 g of N-methylolmethacrylamide, dissolved in 68 g of water,

12 g of N,N-dimethylaminopropylmethacrylamide (“DMAPMAM”),

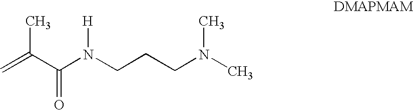

172 g of distilled water and 5 g of concentrated formic acid.

### Mixture I.1.2

2 g of 2,2′-azobis(2-amidinopropane) dihydrochloride in 100 ml of completely ion-free water

A 5 l tank equipped with anchor stirrer, nitrogen connection and three metering devices was charged with an emulsion comprising 250 ml of completely ion-free water, 4 g of compound of formula VII (dissolved in 6 ml of water) and 1 g of formic acid. Thereafter, nitrogen was passed through the resulting emulsion for a total of a quarter of an hour. The emulsion was subsequently heated to 75° C.

Then, 66 g of mixture I.1.1 and 10 g of mixture I.1.2 were added, and the mixture was allowed to start polymerizing. As soon as polymerization had kicked off, the simultaneous addition was commenced of the remainders of mixture I.1.1 and mixture I.1.2. Mixture I.1.1 was added over 2 hours and mixture I.1.2 over 2 hours 15 minutes. The temperature was maintained at 75° C. during the addition.

Completion of the addition was followed by 30 minutes of stirring at 75° C. and subsequently, for deodorization, by the simultaneous metered addition of a solution of 1.7 g of tert-butyl hydroperoxide (70% by weight in water), diluted with 30 ml of distilled water, and of a solution of 9.2 g of acetone disulfite (13% by weight in water), diluted with 30 ml of distilled water, over a period of 90 minutes.

This was followed by cooling down to room temperature. The dispersion thus obtainable was subsequently filtered through a 125 μm net. The filtration took 4 minutes. It removed about 1 g of coagulum.

This gave an aqueous dispersion of (A.1) having a pH of 3.6. Solids content was 37.6% by weight, dynamic viscosity was 245 mPa·s. Particle diameter distribution: maximum at 100 nm. Glass transition temperature T_{g} was −1° C.

### I.2 Preparation of Particles

### I.2.1 Preparation of Particles (B.1)

The following mixtures were prepared:

### Mixture I.2.1

200 g of completely ion-free water

252 g of styrene (42% by weight), 9 g (1.5% by weight) of acrylic acid, 30 g (5% by weight) of allyl methacrylate, 9 g (1.5% by weight) of N,N-dimethylaminopropylmethacrylamide (“DMAPMAM”)

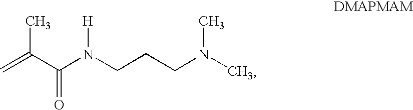

1.5 g of concentrated formic acid, 6 g of compound of formula VII as 40% by weight solution in water

R¹⁵—[N(CH₂CH₂O)₆H]₂ VII

where R¹⁵ is cis(CH₂)₈—CH═CH—(CH₂)₇CH₃.

### Mixture I.2.2: 1.8 g of 2,2′-azobis(2-amidinopropane) dihydrochloride in 50 ml of completely ion-free water

### Mixture I.2.3

265 g of completely ion-free water

6 g of compound of formula VII as 40% by weight solution in water

R¹⁵—[N(CH₂CH₂O)₆H]₂ VII

9 g (15% by weight) of N-methylolmethacrylamide as 15% by weight solution in water,

9 g (1.5% by weight) of N,N-dimethylaminopropylmethacrylamide (“DMAPMAM”),

2.4 g (0.4% by weight) of acrylic acid, 96 g (16% by weight) of styrene, 183.4 g (30.6% by weight) of n-butyl acrylate,

4 g of formic acid.

### Mixture I.2.4: 1.8 g of 2,2′-azobis(2-amidinopropane) dihydrochloride in 50 ml of completely ion-free water

A 5 l tank equipped with stirrer, nitrogen connection and three metering devices was charged with a suspension obtained by mixing 300 ml of completely ion-free water, 1 g of formic acid, 51.5 g of mixture I.2.1 and 15 g of compound of formula VII (see above) as 40% by weight solution in water. Nitrogen was passed for one hour through the emulsion thus obtainable. The emulsion was subsequently heated to 75° C. 10 ml of mixture I.2.2 were added and polymerization kick off was observed. Thereafter, the simultaneous addition was commenced of the remainders of mixture I.2.1 and mixture I.2.2. Mixture I.2.1 was added over 2 hours, mixture I.2.2 over 2 hours 45 minutes. The temperature was maintained at 75° C. during the addition. Completion of the addition of mixture I.2.2 was followed by a further 15 minutes of stirring at 75° C. to obtain core (a.1).

Thereafter, the simultaneous addition was commenced of mixture I.2.3 and mixture I.2.4. Mixture I.2.3 was added over 2 hours, mixture I.2.4 over 2 hours 15 minutes. The temperature was maintained at 75° C. during addition. Envelope (b.1) was obtained.

Completion of addition was followed by 15 minutes of stirring at 75° C. and subsequently, for deodorization, by the simultaneous metered addition of a solution of 2.6 g of tert-butyl hydroperoxide (70% by weight in water), diluted with 30 ml of distilled water, and of a solution of 13.8 g of acetone disulfite (13% by weight in water), diluted with 30 ml of distilled water, over a period of 60 minutes.

This was followed by cooling down to room temperature. The dispersion thus obtainable was subsequently filtered through a 125 μm net. The filtration took 4 minutes. It removed about 2 g of coagulum.

This gave dispersion WD.1 having a pH of 3.8 and comprising particles (B.1). Solids content was 37.3% by weight, dynamic viscosity was 65 mPa·s. Particle diameter distribution: maximum at 80 nm.

### I.2.2 Preparation of Particles (B.2)

The following mixtures were prepared:

### Mixture I.3.1

192 g of completely ion-free water

258.9 g of styrene, 2.1 g of acrylic acid, 30 g of allyl methacrylate, 9 g of DMAPMAM,

1.6 g of compound of formula VII (see above) as 40% by weight solution in water.

The pH of mixture I.3.1 was adjusted to 4.0 with concentrated formic acid.

### Mixture I.3.2: 0.5 g of 2,2′-azobis(2-amidinopropane) dihydrochloride in 100 ml of completely ion-free water

### Mixture I.3.3

286 g of completely ion-free water,

6 g of compound of formula VII (see above) as 40% by weight solution in water,

9 g of N-methylolmethacrylamide as 15% by weight solution in water,

9 g of N,N-dimethylaminopropylmethacrylamide (“DMAPMAM”),

2.1 g of acrylic acid, 96 g of styrene, 183.9 g of n-butyl acrylate,

4 g of formic acid.

### Mixture I.34: 1.5 g of 2,2′-azobis(2-amidinopropane) dihydrochloride in 100 ml of completely ion-free water

A 5 l tank equipped with stirrer, nitrogen connection and three metering devices was charged with 200 ml of completely ion-free water and sufficient concentrated formic acid to set a pH of 4. Nitrogen was passed for one hour through the solution thus obtainable. The solution was subsequently heated to 75° C. Thereafter, the simultaneous addition was commenced of mixture I.3.1 and mixture I.3.2. Mixture I.3.1 was added over 2 hours, mixture I.3.2 over 2 hours 15 minutes. The temperature was maintained at 75° C. during the addition. Completion of the addition of mixture I.3.2 was followed by a further 30 minutes of stirring at 75° C. to obtain core (a.2).

Thereafter, the simultaneous addition was commenced of mixture I.3.3 and mixture I.3.4. Mixture I.3.3 was added over 2 hours, mixture I.3.4 over 2 hours 15 minutes. The temperature was maintained at 75° C. during the addition. Envelope (b.2) was obtained.

Completion of the addition was followed by a further 15 minutes of stirring at 75° C. and subsequently for deodorization, by the simultaneous metered addition of a solution of 2.1 g of tert-butyl hydroperoxide (70% by weight in water), diluted with 30 ml of distilled water, and of a solution of 1.5 g of HO—CH₂SO₂Na, diluted with 30 ml of distilled water, over a period of 60 minutes. This was followed by a further 30 minutes of stirring at 75° C.

This was followed by cooling to room temperature. The dispersions obtainable were subsequently filtered through a 125 μm net. The filtration took 4 minutes. It removed about 2 g of coagulum.

This gave dispersion WD.2 having a pH of 3.4 and comprising particles (B.2). Solids content was 37.9% by weight, dynamic viscosity was 30 mPa·s. Particle diameter distribution: maximum at 334 nm.

Particles (B.1) and (B.2) each comprise cationic particles.

### II. Preparation of Inventive Formulations F.1 To F.4 And of Comparative Formulations V-F.5 To V-F.7

Formulations were each used in a stirred vessel by stirring the respective components of table together and making up to one liter with water.

TABLE 1
Composition of inventive and comparative formulations

| | F.1 | F.2 | F.3 | F.4 | V-F.5 | V-F.6 | V-F.7 |
|---|---|---|---|---|---|---|---|
| Acetic | 1 | 1 | 1 | 1 | 1 | 1 | 1 |
| acid | | | | | | | |
| (g/l) | | | | | | | |
| (B.1) | 15 | 10 | — | — | 30 | — | — |
| (g/l) | | | | | | | |
| (B.2) | — | — | 20 | 15 | — | — | 30 |
| (g/l) | | | | | | | |
| (A.1) | 15 | 20 | 10 | 15 | — | — | — |
| (g/l) | | | | | | | |
| (C1.1) | 45 | 45 | 45 | 45 | 45 | 45 | 45 |
| (g/l) | | | | | | | |
| pH | 4.7 | 4.5 | 4.5 | 4.6 | 4.7 | 4.9 | 4.5 |

(C1.1): Random copolymer of 10% by weight methacrylic acid and 90% by weight CH₂═CHCOO—CH₂—CH₂—O—n—C₆F₁₃ of Mₙ 30000 g/mol (GPC) in aqueous dispersion (20% by weight solids content)

### III. Treatment of Textile

The following textile was used:

Cotton: 1 m×30 cm, 100% woven cotton, bleached, nonmercerized, twill construction, basis weight 196 g/m² (“Co”).

The following equipment was used in all cases:

Pad-mangle: manufactured by Mathis, model HVF12085, contact pressure 1.6 bar. The contact pressure setting in all cases was such that the wet pickup (based on weight of fiber) was 81%. The liquor was at room temperature, unless otherwise stated. Dryer: continuous dryer from Mathis THN 12589

Test methods:

Spray test: AATCC 22-2001, Oil rating: AATCC 118-2002,

Hydrophobicization: AATCC 193-2004, Smoothness: AATCC 124-2001

Wash conditions: delicates cycle at 30° C., 15 g/l of a mild laundry detergent,

Washing machine: Miele Novotronic T440C, Setting: tumbler dry, hand iron moist.

Co was padded with an aqueous liquor as per Table 1 (step 1). This was followed by tenter drying at 110° C. for 2 minutes and thereafter oven drying at 160° C. for 2 minutes to obtain inventive textile Co.1 to Co.4 or comparative textile V-Co.5 to V-Co.7 as per Table 2.

TABLE 2
Treated textiles and their properties

| Treatment with | F.1 | F.2 | F.3 | F.4 | V-F.5 | V-F.6 | V-F.7 |
|---|---|---|---|---|---|---|---|
| Textile | Co.1 | Co.2 | Co.3 | Co.4 | V-Co.5 | V-Co.6 | V-Co.7 |
| Spray test | 100 | 100 | 100 | 100 | 100 | 100 | 100 |
| Oil repellence | 8 | 8 | 8 | 8 | 7 | 5 | 6 |
| Hydrophobicization | 10 | 10 | 10 | 10 | 9 | 6 | 9 |
| Spray test | 70 | 80 | 80 | 80 | 70 | 80 | 70 |
| (after 10 HL) | | | | | | | |
| Oil rating | 7 | 8 | 7 | 7 | 7 | 5 | 6 |
| (after 10 HL) | | | | | | | |
| Hydrophobicization | 10 | 10 | 10 | 10 | 9 | 6 | 7 |
| (after 10 HL) | | | | | | | |

HL: household laundry cycles as described above.

1-12. (canceled)

13. An aqueous formulation comprising
(A) at least one film-forming addition (co)polymer,
(B) particles comprising a core (a) and at least one envelope (b) of a material other than said core (a), and optionally
(C) at least one hydrophobicizing agent,
wherein said core (a) or said envelope (b) comprise a cationic copolymer.

14. The aqueous formulation according to claim 13 wherein said film-forming addition (co)polymer (A) is selected from polyacrylates and polyurethanes.

15. The aqueous formulation according to claim 13 wherein said hydrophobicizing agent (C) is selected from halous polymers (C1), paraffins (C2), compounds having at least one C₁₀-C₆₀-alkyl group per molecule (C3) and silicones (C4).

16. The aqueous formulation according to claim 13 wherein said particles (B) have a number average diameter in the range from 20 to 1000 nm.

17. The aqueous formulation according to claim 13 wherein said particles (B) comprise an envelope (b) comprising a crosslinked or crosslinking-capable copolymer of at least one ethylenically unsaturated carboxylic acid or at least one ester or amide of an ethylenically unsaturated carboxylic acid.

18. A coating on a surface comprising at least one formulation according to claim 13.

19. A process for coating a surface comprising applying at least one aqueous formulation according to claim 13.

20. The process according to claim 19 wherein said surface is contacted with at least one aqueous formulation comprising.
(A) at least one film-forming addition (co)polymer,
(B) particles comprising a core (a) and at least one envelope (b) of a material other than said core (a), and optionally
(C) at least one hydrophobicizing agent,
wherein said core (a) or said envelope (b) comprise a cationic copolymer,
and said surface is thereafter thermally treated.

21. The process according to claim 19 wherein with said surface is treated with a primer (E), thereafter contacted with at least one aqueous formulation comprising.
(A) at least one film-forming addition (co)polymer,
(B) particles comprising a core (a) and at least one envelope (b) of a material other than said core (a), and optionally
(C) at least one hydrophobicizing agent,
wherein said core (a) or said envelope (b) comprise a cationic copolymer,
and is surface is thereafter thermally treated.

22. A coated surface prepared by a process according to claim 19.

23. A process for preparing an aqueous formulation according to claim 13, which comprises mixing together with water
(A) at least one film-forming addition (co)polymer,
(B) particles comprising a core (a) and at least one envelope (b) of a material other than said core (a), wherein said core (a) or said envelope (b) comprise a cationic copolymer,
(C) optionally at least one hydrophobicizing agent, and
(D) optionally at least one auxiliary.
